(19) United States
(12) Patent Application Publication
(10) Pub. No.: US 2004/0239997 A1
(43) Pub. Date: Dec. 2, 2004

(54) Method and apparatus to process facsimile data using a computer

(76) Inventor: Hyung-sik Byun, Gyeonggi-do (KR)

Correspondence Address: STANZIONE & KIM, LLP, 1740 N STREET, N.W., FIRST FLOOR, WASHINGTON, DC, 20036, US

(21) Appl. No.: 10/795,233

(22) Filed: Mar. 9, 2004

(30) Foreign Application Priority Data
May 30, 2003 (KR) 2003-34832

(51) Int. Cl. G06F 15/00; H04N 1/32

(52) U.S. Cl. 358/402; 358/1.15

(57) ABSTRACT

A method and an apparatus to process facsimile data using a computer including storing the facsimile data received in the facsimile, generating receipt information regarding the stored facsimile data, and transmitting the stored facsimile data to the computer based on the generated receipt information, wherein the facsimile data transmitted to the computer is stored, deleted, or printed if necessary. Therefore, the method and the apparatus prevent the facsimile data received in the facsimile or the multifunctional device from being unconditionally printed and selectively store and print only the necessary data. Thus, wasting of memory space and printing paper are prevented.

### CROSS-REFERENCE TO RELATED APPLICATIONS

This application claims the priority of Korean Patent Application No. 2003-34832, filed on May 30, 2003, in the Korean Intellectual Property Office, the disclosure of which is incorporated herein in its entirety by reference.

### BACKGROUND OF THE INVENTION

1. Field of the Invention

The present invention relates to a method and an apparatus to print data received in a facsimile or a multifunctional device having a facsimile function, and more particularly, to a method and an apparatus to process e data using a computer connected to a facsimile or a multifunctional device so that compressed data is transmitted to the computer to print, store, and delete the data.

2. Description of the Related Art

A facsimile or a multifunctional device having a facsimile function is a telecommunication device for transmitting data or receiving data at a receiving point, by decomposing still pictures, such as characters, figures, or photos (hereinafter referred to as ‘facsimile data’), into pixels and converting the facsimile data into an electrical signal for transmission. The facsimile or the multifunctional device also has a function for transmitting documents or photos.

The conventional facsimile or multifunctional device includes a central processing unit (CPU), a memory unit, a control panel unit, an interface unit, and a printing unit.

The CPU controls the facsimile or the multifunctional device according to a predetermined program. The memory unit stores an operation and control program of the CPU and temporarily stores the facsimile data received in the facsimile or the multifunctional device. The control panel unit having a plurality of keys transmits a predetermined control command to the CPU when a predetermined key is selected. The interface unit is connected to an overhead phone or key phone network to exchange a protocol and the facsimile data when transmitting and receiving data in the facsimile. The printing unit prints the facsimile data temporarily stored in the memory unit according to the control of the CPU.

The facsimile or the multifunctional device having the aforementioned elements temporarily stores and prints the facsimile data received regardless of the type and usefulness of the facsimile data after receiving the facsimile data. Accordingly, the conventional facsimile or multifunctional device has a disadvantage in wasting printing paper and memory space since undesired or unnecessary facsimile data is printed and stored.

### SUMMARY OF THE INVENTION

In order to solve the foregoing and/or other problems, the present invention provides a method and apparatus to process facsimile data using a computer capable of selectively storing and printing necessary facsimile data.

Additional aspects and/or advantages of the present invention will be set forth in part in the description which follows and, in part, will be obvious from the description, or may be learned by practice of the invention.

In order to achieve the foregoing and/or other aspects of the present invention, there is provided a method of processing facsimile data in a facsimile using a computer connected to the facsimile, the method comprising storing the facsimile data received in the facsimile, generating receipt information regarding the stored facsimile data, and transmitting the stored facsimile data to the computer based on the generated receipt information. Here, the facsimile data transmitted to the computer is stored, deleted, or printed if necessary.

In order to achieve the foregoing and/or other aspects of the present invention, there is also provided an apparatus to process facsimile data in a facsimile using a computer connected to the facsimile, the apparatus comprising a memory that stores the received facsimile data, a receipt information generator that generates receipt information regarding the stored facsimile data, and a data transmission processor that transmits the stored facsimile data to the computer based on the generated receipt information. Here, the facsimile data transmitted to the computer is stored, deleted, or printed if necessary.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a flowchart explaining a method of processing facsimile data using a computer according to an embodiment of the present invention;

FIG. 2 is a detailed flowchart explaining operation 16 of the method shown in FIG. 1, according to another embodiment of the present invention;

FIG. 3 is a block diagram explaining an apparatus to process facsimile data using a computer according to another embodiment of the present invention; and

FIG. 4 is a block diagram explaining an apparatus to process facsimile data in a facsimile and a computer according to another embodiment of the present invention.

### DETAILED DESCRIPTION OF THE PREFERRED EMBODIMENTS

References will now be made in detail to the embodiments of the present invention, examples of which are illustrated in the accompanying drawings, wherein like reference numerals refer to the like elements throughout. The embodiments are described below in order to explain the present invention by referring to the figures.

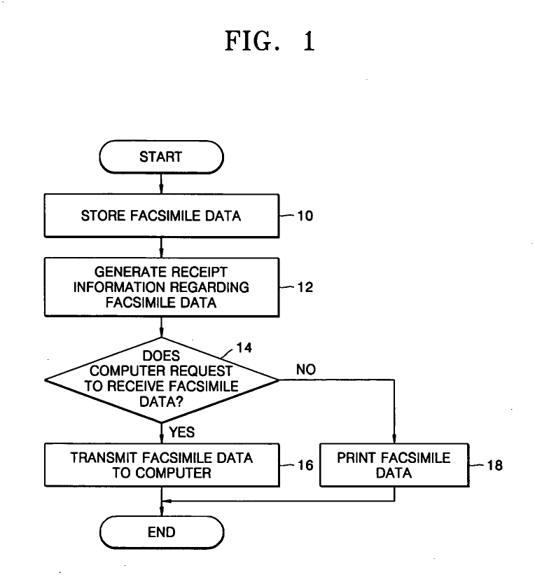

FIG. 1 is a flowchart explaining a method of processing facsimile data by using a computer, according to an embodiment of the present invention. FIG. 1 includes compressing and storing received facsimile data, and transmitting the stored facsimile data using a computer (operations10 through 18).

More specifically, first, the facsimile data received by a facsimile is stored in a data storage space (operation 10). Here, the facsimile includes a multifunctional device with a facsimile function.

The received facsimile data is compressed and stored. A method of compressing the facsimile data will now be described.

First, a line, for example, a first line, of the data is received as effective data and compressed. Thereafter, the data of another line, for example, a second line, next to the first line is removed and the data of another line, for example, a third line next to the second line is received and compressed. Respective dots of the received lines, for example, the first and third lines, are processed in the same way. Specifically, a dot of each line is received as an effective dot and another dot, for example, a second dot, next to the effective dot is removed. Then, another dot, for example, a third dot, next to the second dot is received, and by this process, a line of data is compressed. As a result, the original facsimile data is compressed to up to about a half in size. The present invention exemplifies a 50% data compression, but the compression ratio can be adjusted to condensing of, for example, 25% or 75%.

After operation 10, receipt information of the stored facsimile data is generated (operation 12). The receipt information of the stored facsimile data contains brief information on the facsimile data such as the number, a type, a size, and a receipt time of the data received in the facsimile or the multifunctional device. A computer connected to the facsimile or the multifunctional device uses the receipt information to request the facsimile and the multifunctional device to transmit the data.

After operation 12, it is decided whether transmission of the stored facsimile data to the computer is required (operation 14). A user requests the transmission of the stored facsimile data by using the computer connected to the facsimile or the multifunctional device.

If transmission of the data to the computer is required, the facsimile data is transmitted to the computer based on the receipt information (operation 16).

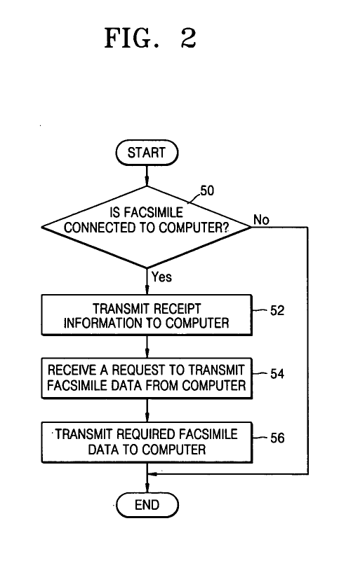

FIG. 2 is a detailed flowchart explaining operation 16 of FIG. 1 according to another embodiment of the present invention. The operation 16 of FIG. 2 includes checking whether the facsimile or the multifunctional device is connected to the computer, and transmitting the facsimile data to the computer according to a result of the checking operation (operation 50 through 56).

Referring to FIGS. 1 and 2, first, it is checked whether the facsimile or the multifunctional device is connected to the computer (operation 50). If the facsimile or the multifunctional device is not connected to the computer, the method is completed (terminated) since the facsimile data cannot be transmitted.

When the facsimile or the multifunctional device is connected to the computer, the receipt information is transmitted to the computer (operation 52). The connection of the facsimile or the multifunctional device to the computer forms a network where data can be exchanged between the facsimile (or the multifunctional device) and the computer via wire or wireless communication. In this case, the facsimile (or the multifunctional device) and the computer are powered on. Once the receipt information stored in the facsimile or the multifunctional device is transmitted to the computer, the receipt information is preferably deleted from the facsimile or the multifunctional device so as to secure the data storage space.

If the computer connected to the facsimile or the multifunctional device receives the receipt information, the computer requests the facsimile or the multifunctional device to transmit the facsimile data corresponding to the receipt information.

After operation 52, the facsimile data corresponding to the receipt information is requested by the computer (operation 54). The user can select the facsimile data from the receipt information transmitted to the computer, and the facsimile receives a request from the computer to transmit the facsimile data selected by the user to the computer.

After operation 54, the facsimile data requested is transmitted to the computer (operation 56). That is, the facsimile or the multifunctional device withdraws the requested facsimile data from the data storage space of the facsimile or the multifunctional device and transmits it to the computer. The transmitted facsimile data may be deleted from the data storage space of the facsimile or the multifunctional device to secure the data storage space in a memory of the facsimile or the multifunctional device. Accordingly, new data can be stored in the above data storage space of the facsimile or the multifunctional device.

The data transmitted to the computer is displayed in a display screen, thus enabling the user to check the facsimile data.

Among the facsimile data displayed, the data requested to be stored or deleted by the user is stored or deleted. In addition, the data requested to be printed can be printed using the printer or the multifunctional device having printing capability. The facsimile data transmitted to the computer may be compressed data. In this case, it is required that the compressed facsimile data is decompressed and printed. According to an aspect of the present invention, dithering or image scaling may be used in recovering the compressed data. Dithering technology is used to similarly generate a color picture beyond a predetermined resolution of computer graphics. For instance, a mono printer using the dithering technology can display a whole picture in grey with a specific graduation according to a ratio of black to white dots. Moreover, a color printer using the dithering technology can display the whole picture in pink with various graduations according to a ratio of red and white dots. Image scaling is technology entailing the adjustment of the size of a total or part of a picture. In a method of enlarging pictures, various means of enlarging, such as magnification, scaling up, zooming, upsampling, or stretching, can be used to enlarge the pictures. Minification, shrinking, scaling down, decimation, and down sampling are examples in the method of minimizing the pictures.

In the meantime, if the transmission of the stored facsimile data to the computer is not required in operation 14, the stored facsimile data is printed (operation 18). When the transmission of the stored facsimile data is not required for a predetermined time, the stored facsimile is printed.

An apparatus to process facsimile data using a computer will now be explained with reference to the attached drawings.

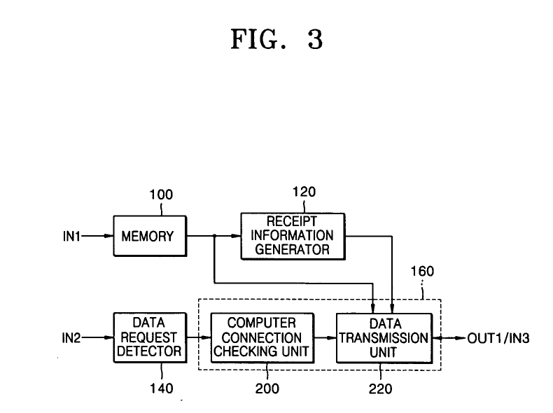

FIG. 3 is a block diagram explaining an apparatus to process the facsimile data by using the computer according to another embodiment of the present invention. The apparatus includes a memory 100, a receipt information generator 120, a data request detector 140, and a data transmission processor 160.

The memory 100 receives and stores facsimile data input via an input terminal IN1 using a wired or wireless communication. Here, the facsimile data is compressed and stored in the memory 100. The facsimile data stored in the memory 100 is output to the receipt information generator 120 and the data transmission processor 160.

The receipt information generator 120 receives the facsimile data from the memory 100, generates receipt information, and outputs the receipt information to the data transmission processor 160. Once the receipt information is sent to the data transmission processor 160, the receipt information generator 120 deletes the receipt information from its data storage space so as to store receipt information which will be newly generated when new facsimile data is received.

The data request detector 140 detects whether transmission of the stored facsimile data to a computer is requested. If a request to transmit the data to the computer is input through an input terminal IN2, the data request detector 140 detects the transmission request and outputs a detection result to the data transmission processor 160.

The data transmission processor 160 transmits the stored facsimile data to the computer, based on the received receipt information. That is, when the data request detector 140 sends a request to transmit the facsimile data, the data transmission processor 160 transmits the facsimile data stored in the memory 100 to the computer via an output terminal OUT1.

The data transmission processor 160 includes a computer connection checking unit 200 and a data transmission unit 220.

The computer connection checking unit 200 checks whether the facsimile or the multifunctional device is connected to the computer. More specifically, the computer connection check unit 200 receives the detection result from the data request detector 140, checks whether the facsimile or the multifunctional device is connected to the computer, and outputs a result of the checking operation to the data transmission unit 220.

The data transmission unit 220 sends the receipt information or the facsimile data to the computer. The data transmission unit 220 transmits the receipt information output from the receipt information generator 120 to the computer via the output terminal OUT1, in response to the checking result from the computer connection checking unit 200. Then, the data transmission unit 220 receives a request to transmit the facsimile data from the computer via the input terminal IN3, and transmits the facsimile data stored in the memory 100 to the computer via the output terminal OUT1 according to the request.

The facsimile data, which is transmitted from the data transmission unit 220 to the computer, is stored in or deleted from the memory according to a user input. In addition, the transmitted facsimile data may be restored as the original data if the transmitted facsimile data has been compressed, and printed using the dithering or image scaling method according to a user input.

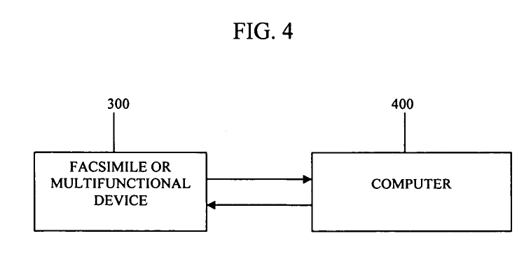

FIG. 4 is a block diagram explaining an apparatus to process facsimile data in a facsimile (or multifunctional device) 300 and a computer 400 according to another aspect to the present invention. Referring to FIG. 4, the facsimile or multifunctional device 300 is a device having a facsimile function in which facsimile data is received from an external source through a wired or wireless network, the received facsimile data is compressed, data information corresponding to at least one characteristic of the received facsimile data is generated, and the received or compressed facsimile data and the data information are transmitted to an external device, for example, the computer 400. The computer 400 may be a microprocessor to control the facsimile or the multifunctional device 300 to perform the above-described functions as shown in FIGS. 1-4 according to an aspect of the present invention.

As described above, a method and apparatus to process facsimile data using the computer according to the present invention selectively stores and prints only the necessary data by preventing the data received in the facsimile or the multifunctional device from being unconditionally printed. Thus, wasting of memory space and printing paper can be prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of processing facsimile data in a facsimile using a computer connected to the facsimile, the method comprising:
storing the facsimile data;
generating receipt information regarding the stored facsimile data; and
transmitting the stored facsimile data to the computer based on the generated receipt information,
wherein the facsimile data transmitted to the computer is stored, deleted, or printed if necessary.

2. The method of claim 1, wherein during the storing of the facsimile data, the received facsimile data is compressed.

3. The method of claim 1, wherein the operation of transmitting the stored facsimile data comprises:
detecting whether transmission of the stored facsimile data to the computer is requested;
transmitting the stored facsimile data to the computer when the transmission of the stored facsimile data to the computer is requested; and
printing the stored facsimile data when the transmission of the stored facsimile data to the computer is not requested.

4. The method of claim 1, wherein the operation of transmitting the stored facsimile data to the computer comprises:
determining whether the facsimile is connected to the computer;
transmitting the receipt information to the computer when the facsimile is connected to the computer;
receiving a request to send the facsimile data corresponding to the receipt information from the computer; and
transmitting the requested facsimile data to the computer.

5. An apparatus to process facsimile data in a facsimile using a computer connected to the facsimile, the apparatus comprising:
a memory that stores the received facsimile data;
a receipt information generator that generates receipt information regarding the stored facsimile data; and
a data transmission processor that transmits the stored facsimile data to the computer, based on the generated receipt information,
wherein the facsimile data transmitted to the computer is stored, deleted, or printed if necessary.

6. The apparatus of claim 5, wherein the data transmission processor compresses the received facsimile data and stores the compressed facsimile data.

7. The apparatus of claim 5, further comprising:
a data request detector that detects whether transmission of the stored facsimile data to the computer is required,
wherein the stored facsimile data is transmitted to the computer or printed based on the detecting result.

8. The apparatus of claim 5, wherein the data transmission processor comprises:
a computer connection checking unit that checks whether the facsimile is connected to the computer; and
a data transmission unit that transmits the receipt information to the computer based on the checking result received from the computer connection checking result, or transmits the facsimile data corresponding to the receipt information to the computer when the computer sends the data transmission unit a request to transmit the facsimile data.

9. A method of processing facsimile data in a device having a facsimile function, the method comprising:
storing the facsimile data;
generating receipt information regarding the stored facsimile data; and
transmitting the stored facsimile data to an external device based on the generated receipt information.

10. The method of claim 9, wherein the storing of the facsimile data comprises:
compressing the facsimile data and storing the compressed facsimile data as the stored facsimile data.

11. The method of claim 9, wherein the generating of the receipt information comprises:
generating information corresponding to at least one of the number, a type, a size, and a receiving time of the facsimile data as the receipt information.

12. The method of claim 9, wherein the generating of the receipt information comprises:
transmitting the receipt information to the external device.

13. The method of claim 12, wherein the transmitting of the stored facsimile data comprises:
receiving a request from the external device according to the transmitted receipt information; and
transmitting the stored facsimile data according to the received request.

14. The method of claim 9, wherein the transmitting of the stored facsimile data comprises:
printing the stored facsimile data in one of the device and the external device.

15. An apparatus to process facsimile data in a device having a facsimile function, comprising:
a memory to store the facsimile data;
a receipt information generator to generate receipt information regarding the stored facsimile data; and
a data transmission processor to transmit the stored facsimile data to an external device based on the generated receipt information.

16. The apparatus of claim 15, wherein one of the receipt information generator and the data transmission processor compresses the facsimile data to store the compressed facsimile data as the stored facsimile data.

17. The apparatus of claim 15, wherein the receipt information generator generates information corresponding to at least one of the number, a type, a size, and a receiving time of the facsimile data as the receipt information.

18. The apparatus of claim 15, wherein the receipt information generator transmits the receipt information to the external device.

19. The apparatus of claim 18, wherein the data transmission processor receives a request from the external device according to the transmitted receipt information and transmits the stored facsimile data according to the received request.

20. The apparatus of claim 15, wherein one of the device and the external device prints the stored facsimile data.
